(19) United States
(12) Patent Application Publication
(10) Pub. No.: US 2013/0322985 A1
(43) Pub. Date: Dec. 5, 2013

(54) RETENTION ASSEMBLY INCLUDING SLEEVE

(71) Applicants: Eugene C. Gasmen, Rocky Hill, CT (US); Christopher St. Mary, Hebron, CT (US)

(72) Inventors: Eugene C. Gasmen, Rocky Hill, CT (US); Christopher St. Mary, Hebron, CT (US)

(73) Assignee: United Technologies Corporation, Hartford, CT (US)

(21) Appl. No.: 13/484,415

(22) Filed: May 31, 2012

(51) Int. Cl. F16B 33/00

(52) U.S. Cl. 411/367

(57) ABSTRACT

An assembly includes a first part, a second part, a sleeve, and a fastener. The first part has a first hole with a threaded portion therein. Additionally, the first hole has a first counterbore. The second part has a second hole with a second counterbore. The second counterbore is arranged to oppose the first counterbore. The sleeve is inserted into the second counterbore and extends to insert into the first counterbore. The fastener has a threaded end portion and a reduced diameter portion and extends through the first hole and into the second hole. The reduced diameter portion of the fastener is surrounded by the sleeve when the fastener is inserted to mount the first part with the second part.

### BACKGROUND

The present invention relates to a retention assembly, and more particularly to a retention assembly for mounting an actuator assembly to a torque box.

A gas turbine engine includes a compressor with multiple rows of rotor blades spaced between multiple rows of stator vanes to gradually compress air for delivery to a combustor. Many gas turbine engines include a first stage of inlet guide vanes that are variable in order to change the angle of each guide vane to respond to varying operating conditions. Subsequent compressor stages of variable guide vanes can also be utilized and operate in a similar manner.

These variable vanes are pivotably connected to an actuator via a linkage system. More particularly, a radial extending vane stem (trunnion) passes through a hole formed within the engine casing. Each vane stem is coupled to a linkage that is pivotally supported from a torque box assembly. The actuator is mounted to the torque box and drives the linkages which pivot about the torque box.

Typically, the actuator is mounted on the exterior case of the engine to a bulky support bracket or housing. Large dowel pins are used to secure the actuator in place. Because the actuator is mounted to the torque box, additional linkages are used to transfer movement from the actuator to the linkages coupled at the torque box.

### SUMMARY

An assembly includes a first part, a second part, a sleeve, and a fastener. The first part has a first hole with a threaded portion therein. Additionally, the first hole has a first counterbore. The second part has a second hole with a second counterbore. The second counterbore is arranged to oppose the first counterbore. The sleeve is inserted into the second counterbore and extends to insert into the first counterbore. The fastener has a threaded end portion and a reduced diameter portion and extends through the first hole and into the second hole. The reduced diameter portion of the fastener is surrounded by the sleeve when the fastener is inserted to mount the first part with the second part. An insert such as a helicoil or key lock used in the second part as a locking feature and to protect the second part from damaging threads.

In another aspect, kit includes an actuator, a torque box, a sleeve, and a fastener. The actuator has a first hole with a threaded portion therein. Additionally, the first hole has a first counterbore. The torque box has a second hole with a second counterbore. The second counterbore is sized to interface with the first counterbore. The sleeve is insertable into and removable from both the second counterbore and the first counterbore. The fastener has a threaded end portion and a reduced diameter portion and is adapted to be threadably captured in both the first hole and the second hole. The sleeve is adapted to have a clearance with the threaded portion of the fastener.

### BRIEF DESCRIPTION OF THE DRAWINGS

FIG. 1 is an elevated semi-exploded perspective view of an actuator mounted to a torque box utilizing a retention assembly.

FIG. 2 is cross-sectional view of the retention assembly of FIG. 1 disposed within the actuator and torque box.

### DETAILED DESCRIPTION

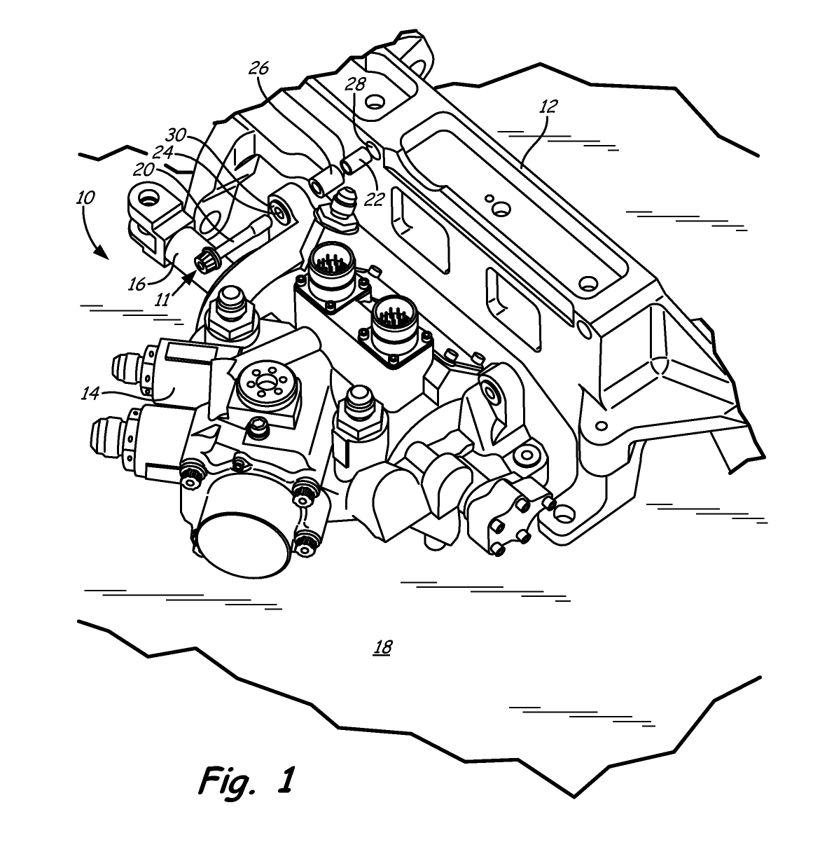

FIG. 1 shows a perspective semi-exploded view of an assembly 10 retained by a retention assembly 11. Assembly 10 includes a torque box 12, an actuator 14, and a piston 16. Assembly 10 is mounted on to an engine case 18 via torque box 12. Retention Assembly 11 includes components of assembly 10 and additionally a fastener 20, an insert 22, a first hole 24, an alignment sleeve 26, a second hole 28, and a washer 30.

Torque box 12 comprises a metal frame with a hollow interior. Torque box 12 has a first side adapted to mount with actuator 14 and a second side (disposed substantially perpendicular to the first side) adapted to mount on engine case 18. Actuator 14 mounts to and extends from torque box 12. Actuator 14 has piston 16 such as an arm extending therefrom. Actuator 14 is coupled to and moves additional linkages (not shown) via piston 16 which moves linearly relative to actuator 14. In the mounting arrangement shown, actuator 14 and linkage 16 extend above engine case 18 mounted to torque box 12.

In FIG. 1, fastener 20 comprises a reduced shank bolt with a necked down middle portion. Fastener 20 is disposed at an end portion of actuator 14 and aligns with other components of retention assembly 11. Insert 22 is capable of insertion into second hole 28 in torque box 12. Sleeve 26 is disposed between actuator 14 and torque box 12 and is capable of insertion into both components. First hole 24 is sized to receive both sleeve 26 and fastener 20. Upon insertion into first hole 24, a head 41 of fastener 20 contacts washer 30, which is disposed along an outer surface of actuator 14.

Retention assembly 11 simplifies installation of actuator 14 on torque box 12. More particularly, sleeve 26 is received in both actuator 14 and torque box 12 and extends between both components. Sleeve 26 is inserted into torque box 12 and press fit. Once sleeve 26 is inserted into torque box 12, actuator 14 can be mounted onto the protruding portion of sleeve 26. Once actuator is placed on sleeve 26, sleeve 26 acts to reduce or eliminate substantial lateral motion of the actuator 14 relative to the torque box 12. Sleeve 26 then allows for pivotal movement of the actuator 14 relative to the torque box 12 to align the parts in a desired position. Once the desired position is achieved, fastener 20 (and additional fasteners not shown) can be threaded to clamp the actuator 14 in place on the torque box 12. Thus, sleeve 26 acts to align actuator 14 relative to torque box 12 such that actuator 14 does not shift before all fasteners are tightened to hold the actuator 14 in place.

Assembly 10 additionally is beneficially provided with a captured fastener arrangement such that actuator 14 can more easily be replaced or assembled as a line replaceable unit. More particularly, fastener 20 comes pre-threaded through hole 24 prior to assembly of actuator 14 on torque box 12. Thus, fastener 20 is captured and cannot fall free of actuator 14 during the assembly or disassembly process. During disassembly, fastener 20 is threaded free of insert 22 and retracted past sleeve 26 in order to remove actuator 14 and fastener 20 from torque box 12. However, fastener 20 would not be free to completely slide free of torque box 12 at this point but would additionally have to be threaded through hole 24 in order to remove fastener 20 from actuator 14. Such an arrangement reduces lost components and the chance of loose fasteners 20 being introduced to the gas turbine engine or workplace.

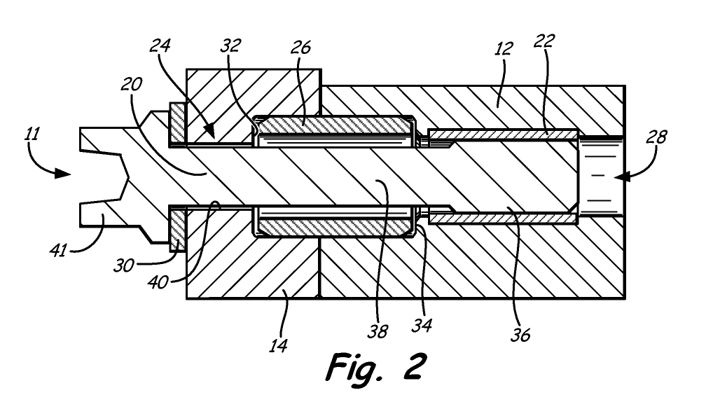

FIG. 2 shows a cross-sectional view of one embodiment of retention assembly 11. In addition to the components described previously, first hole 24 includes a counterbore 32. Second hole 28 includes a second counterbore 34. Fastener 20 includes a threaded end portion 36 and a reduced diameter shanked portion 38. First hole 24 additionally includes a threaded portion 40.

As illustrated in FIG. 2, actuator 14 is mounted in abutting contact on torque box 12. Fastener 20 extends through to thread with insert 22, which is inserted in second hole 28 distal to sleeve 26. Threaded end portion 36 threads with insert 22 upon insertion of fastener 20. The insert 22 can be a helicoil or key lock, which has a locking feature and which protects the hole 28 in the torque box 12 from damaging threads.

Sleeve 26 extends between actuator 14 and torque box 12 and is received in first counterbore 32 and second counterbore 34. A clearance is provided between a bottom of the first counterbore 32 and an end of the sleeve 26. This allows actuator 14 to lie flush on torque box 12. Additionally, sleeve 26 is provided with a small clearance relative to the diameter of the first counterbore 32. This clearance allows actuator 14 to be easily inserted and removed from torque box 12. An inner diameter of sleeve 26 has clearance with threaded end portion 36 allowing for withdrawal of fastener 20.

Fastener 20 extends through first hole 24 and is surrounded by sleeve 26 when the fastener 20 is inserted to mount actuator 14 to torque box 12 as illustrated. Reduced diameter portion 38 extends through and has a clearance with first threaded portion 40 of the first hole 24. Reduced diameter portion 38 is surrounded by sleeve 26 when fastener 20 is inserted.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

In other embodiments, the assembly and/or kit can include one or more of the following components or features. In a further embodiment of any of the foregoing embodiments, the assembly may additionally or alternatively include a clearance between an axial bottom of the first counterbore and an end of the sleeve. In a further embodiment of any of the foregoing embodiments, the assembly may additionally or alternatively include the reduced diameter portion extends past the first threaded portion of the first hole and is surrounded by the sleeve when the fastener is inserted to mount the first part with the second part. In a further embodiment of any of the foregoing embodiments, the assembly may additionally or alternatively include the sleeve eliminates substantial lateral motion of the first part relative to the second part prior to insertion of the fastener. In a further embodiment of any of the foregoing embodiments, the assembly may additionally or alternatively include the sleeve allows for pivotal motion of the first part relative to the second part to align the parts in a desired position prior to insertion of the fastener. In a further embodiment of any of the foregoing embodiments, the assembly may additionally or alternatively include the threaded end portion has a clearance relative to an inner diameter of the sleeve. In a further embodiment of any of the foregoing embodiments, the assembly may additionally or alternatively include the first part comprises an actuator. In a further embodiment of any of the foregoing embodiments, the assembly may additionally or alternatively include the second part comprises a torque box.

In a further embodiment of any of the foregoing embodiments, the assembly may additionally or alternatively include a threaded insert positioned in a distal portion of the second counterbore with the insert threads with the threaded end portion of the fastener. In a further embodiment of any of the foregoing embodiments, the assembly may additionally or alternatively include the threaded end portion of the fastener is threaded out of the insert and retracted past the sleeve to remove the first part and fastener from the second part. In a further embodiment of any of the foregoing embodiments, the assembly may additionally or alternatively include the threaded end portion of the fastener is threaded past the threaded portion of the first hole to remove the fastener from the first part.

In a further embodiment of any of the foregoing embodiments, the kit may additionally or alternatively include a clearance between an axial bottom of the first counterbore and an end of the sleeve upon assembly of the kit. In a further embodiment of any of the foregoing embodiments, the kit may additionally or alternatively include the reduced diameter portion of the fastener is adapted to extend through the first threaded portion of the first hole with a clearance and is surrounded by the sleeve when the fastener is inserted to mount the actuator with the torque box. In a further embodiment of any of the foregoing embodiments, the kit may additionally or alternatively include the sleeve eliminates substantial lateral motion of the actuator relative to the torque box when the sleeve is inserted in both the first counterbore and second counterbore. In a further embodiment of any of the foregoing embodiments, the kit may additionally or alternatively include the sleeve allows for pivotal motion of the actuator relative to the torque box to align the parts in a desired position prior to insertion of the fastener through the first hole and into the second hole. In a further embodiment of any of the foregoing embodiments, the kit may additionally or alternatively include the threaded end portion is provided with a clearance relative to an inner diameter of the sleeve.

In a further embodiment of any of the foregoing embodiments, the kit may additionally or alternatively include a threaded insert positioned in a distal portion of the second counterbore where the insert threads with the threaded end portion of the fastener upon insertion of the fastener into the second hole. In a further embodiment of any of the foregoing embodiments, the kit may additionally or alternatively include the threaded end portion of the fastener can additionally be adapted to be threaded out of the insert and retracted past the sleeve to allow for removal of the actuator and fastener from the torque box. In a further embodiment of any of the foregoing embodiments, the kit may additionally or alternatively include the threaded end portion of the fastener is adapted to be threaded past the threaded portion of the first hole to allow for removal of the fastener from the assembly.

1. An assembly comprising:
a first part having a first hole with a threaded portion and a first counterbore;
a second part having a second hole with a second counterbore opposing the first counterbore;
a sleeve inserted in the second counterbore and extending to insert in the first counterbore; and
a fastener having a threaded end portion and a reduced diameter portion, wherein the fastener extends through the first hole and into the second hole and is surrounded by the sleeve when the fastener is inserted to mount the first part with the second part.

2. The assembly of claim 1, wherein a clearance is provided between an axial bottom of the first counterbore and an end of the sleeve.

3. The assembly of claim 1, wherein the reduced diameter portion extends past the first threaded portion of the first hole and is surrounded by the sleeve when the fastener is inserted to mount the first part with the second part.

4. The assembly of claim 1, wherein the sleeve eliminates substantial lateral motion of the first part relative to the second part prior to insertion of the fastener.

5. The assembly of claim 4, wherein the sleeve allows for pivotal motion of the first part relative to the second part to align the parts in a desired position prior to insertion of the fastener.

6. The assembly of claim 1, wherein the threaded end portion has a clearance relative to an inner diameter of the sleeve.

7. The assembly of claim 1, further comprising a threaded insert positioned in a distal portion of the second counterbore, wherein the insert threads with the threaded end portion of the fastener.

8. The assembly of claim 7, wherein the threaded end portion of the fastener is threaded out of the insert and retracted past the sleeve to remove the first part and fastener from the second part.

9. The assembly of claim 8, wherein the threaded end portion of the fastener is threaded past the threaded portion of the first hole to remove the fastener from the first part.

10. The assembly of claim 1, wherein the first part comprises an actuator.

11. The assembly of claim 1, wherein the second part comprises a torque box.

12. A kit comprising:
an actuator having a first hole with a threaded portion and a first counterbore;
a torque box having a second hole with a second counterbore sized to interface with the first counterbore;
a sleeve insertable in and removable from both the second counterbore and the first counterbore; and
a fastener having a threaded end portion and a reduced diameter portion, wherein threaded end portion is adapted to be threadably captured in both the first hole and the second hole, and wherein the threaded end portion is adapted to have a clearance with the sleeve.

13. The kit of claim 12, wherein a clearance is provided between an axial bottom of the first counterbore and an end of the sleeve upon assembly of the kit.

14. The kit of claim 12, wherein the reduced diameter portion is adapted to extend through the first threaded portion of the first hole with a clearance and is surrounded by the sleeve when the fastener is inserted to mount the actuator with the torque box.

15. The kit of claim 12, wherein the sleeve eliminates substantial lateral motion of the actuator relative to the torque box when the sleeve is inserted in both the first counterbore and second counterbore.

16. The kit of claim 15, wherein the sleeve allows for pivotal motion of the actuator relative to the torque box to align the parts in a desired position prior to insertion of the fastener through the first hole and into the second hole.

17. The kit of claim 12, wherein the threaded end portion is provided with a clearance relative to an inner diameter of the sleeve.

18. The kit of claim 12, further comprising a threaded insert positioned in a distal portion of the second counterbore, wherein the insert threads with the threaded end portion of the fastener upon insertion of the fastener into the second hole.

19. The kit of claim 18, wherein the threaded end portion of the fastener is adapted to be threaded out of the insert and retracted past the sleeve to allow for removal of the actuator and fastener from the torque box.

20. The kit of claim 19, wherein the threaded end portion of the fastener is adapted to be threaded past the threaded portion of the first hole to allow for removal of the fastener from the assembly.
